(19) United States
(12) Patent Application Publication
(10) Pub. No.: US 2021/0245740 A1
(43) Pub. Date: Aug. 12, 2021

(54) VEHICLE DRIVING ASSIST SYSTEM FOR SAFE MOTORCYCLE LANE SPLITTING

(71) Applicant: Karma Automotive LLC, Irvine, CA (US)

(72) Inventor: Todd Maurice GEORGE, Trabuco Canyon, CA (US)

(73) Assignee: Karma Automotive LLC, Irvine, CA (US)

(21) Appl. No.: 16/788,080

(22) Filed: Feb. 11, 2020

(51) Int. Cl. B60W 30/09; B60W 30/095; B60W 30/18; B60W 50/16; B60R 11/04

(52) U.S. Cl. CPC B60W 30/09; B60W 30/0956; B60W 30/18163; B60W 50/16; B60W 2420/52; B60W 2554/4026; B60W 2554/4045; B60W 2552/53; B60W 2420/42; B60R 11/04

(57) ABSTRACT

A driving assist system for permitting safe motorcycle lane splitting for use with either an automated driving assist system (which helps a person drive a vehicle) or with an autonomous driving system (which drives the vehicle for the person) having sensors for detecting a motorcycle approaching the vehicle from behind and a control system for determining which side of the motor vehicle the motorcycle will pass and then steering the motor vehicle towards the opposite side of the traffic lane (but without crossing into another lane or otherwise leaving the lane), to increase the safe passing distance between the motorcycle and the side of the motor vehicle. Mechanisms are also optionally provided to warn the driver that a motorcycle is approaching and that the motor vehicle will be maneuvering to avoid too close an approach to the motorcycle.

### BACKGROUND

The present system relates to vehicle automatic driving assist systems and to autonomous driving vehicles.

In certain jurisdictions (such as California), motorcycle lane splitting is legal. In these jurisdictions, motorcycles are legally permitted to pass cars and other motor vehicles by “splitting” the traffic lane with the car already in the lane. In this application the term “motor vehicle” refers to automobiles, trucks and other passenger vehicles capable of being operated on highways including, for example, highways. These motor vehicles include vehicles powered by a variety of means including, for example, a conventional internal combustion engine or an electric propulsion system or a hybrid system.

Unfortunately, car and truck drivers are too often surprised by motorcycles passing their vehicles at a high rate of speed (and passing on either side of their vehicles). The problem of motorcycles passing cars or trucks becomes especially dangerous when the car driver is about to change lanes. This problem often occurs when the motorcycle is speeding between two lanes of stopped cars (such as when the motorcycle is lane-splitting to move to the front of a traffic jam).

More and more cars and trucks operate with automatic driver assist systems (which help the driver drive their car by sensing objects around the car), or with autonomous vehicle driving systems (in which the car drives itself). In both of these cases, it would instead be desirable to warn these drivers of quickly approaching motorcycles (which approach from behind the rear of the car where they can't be easily seen by the car's driver). It would be especially desirable that such driver assist systems or autonomous driving systems drive the car in a manner that increases safety for the motorcycle during lane splitting.

### SUMMARY

In preferred aspects, the disclosed system provides a driving assist system for permitting safe motorcycle lane splitting, comprising: (a) a motor vehicle; (b) at least one of an automated driving assist system or an autonomous driving system operating in the motor vehicle; (c) sensors on the motor vehicle for detecting the presence and motion of objects surrounding the motor vehicle; and (d) a control system within the automated driving assist system or the autonomous driving system for: (i) sensing a motorcycle approaching the motor vehicle when the motorcycle and the motor vehicle are both traveling in the same direction and the motorcycle is approaching the rear of the motor vehicle; (ii) determining whether the motorcycle will pass the motor vehicle on the left side or the right side of the motor vehicle, and then; (iii) controlling the automated driving assist or autonomous driving system to steer the motor vehicle either: (A) to the right side of a traffic lane if the motorcycle will pass on the left side of the motor vehicle, or (B) to the left side of the traffic lane if the motorcycle will pass on the right side of the motor vehicle.

In optional aspects, the system further comprises a warning system that alerts the driver that the motorcycle will pass the motor vehicle and that the motor vehicle will therefore move to one side of the traffic lane (to permit safe lane splitting with the motorcycle). This warning system may optionally include a mechanism for vibrating the steering wheel, or a light on a dashboard or on the rear-view mirror or an audible chime.

In preferred aspects, the control system determines that a sensed object is a motorcycle by determining the size and speed of the sensed object. The sensors that sense the presence of the motorcycle may optionally be a LIDAR system or a camera system. Other sensing systems are also contemplated, all keeping within the scope of the present invention.

The present system also includes a method of permitting safe motorcycle lane splitting with a motor vehicle having an automated driving assist or an autonomous driving system, comprising: sensing a motorcycle approaching a motor vehicle, wherein the motorcycle and the motor vehicle are traveling in the same direction and the motorcycle is approaching the rear of the motor vehicle; determining whether the motorcycle will pass the motor vehicle on the left side or the right side of the motor vehicle, and then; controlling an automated driving assist or an autonomous driving system in the motor vehicle to steer the motor vehicle to: (i) the right side of a traffic lane if the motorcycle will pass on the left side of the motor vehicle, or (ii) the left side of the traffic lane if the motorcycle will pass on the right side of the motor vehicle.

### BRIEF DESCRIPTION OF THE DRAWINGS

FIG. 1 is a view of several cars on a freeway showing a motorcycle preparing to lane split.

FIG. 2 is a view of the cars and motorcycle of FIG. 1 with one of the cars being outfitted with the present system during the subsequent lane splitting. (FIG. 2 illustrates a later period of time than FIG. 1).

FIG. 3 is a view of the cars and motorcycle of FIG. 1, but with two of the cars being outfitted with the present system during the lane splitting.

FIG. 4 is an illustration of the warning system of the of the present system vibrating a steering column, providing a warning light and a chime alert.

### DETAILED DESCRIPTION

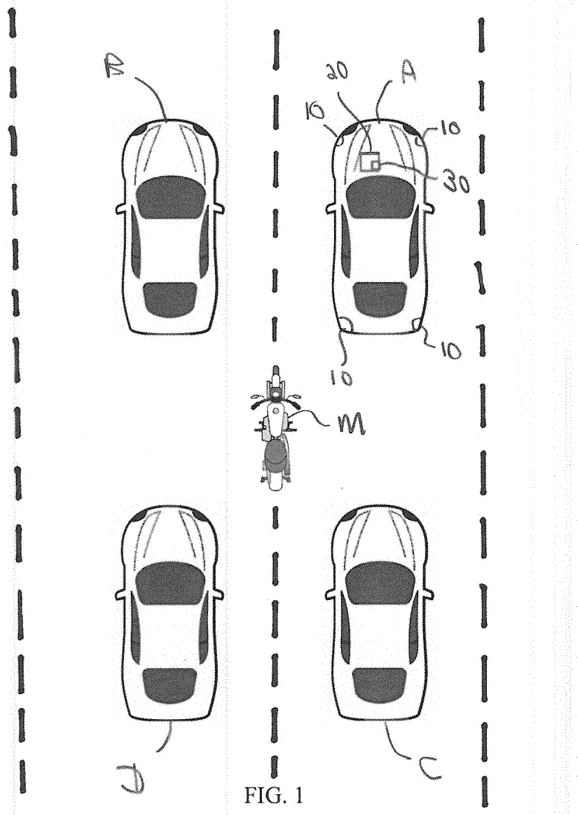

FIG. 1 shows several cars A, B, C and D travelling on a road, with both lanes of traffic heading in the same direction. It is to be understood that FIG. 1 is only illustrative and as such FIG. 1 may be illustrating a two-lane road with all traffic heading in the same direction, or two lanes of a wider four lane two direction road with the lanes and traffic travelling in the opposite direction removed for clarity of illustration.

Cars A, B, C and D are all travelling in the same direction with cars A and C travelling in the rightmost lane and cars B and D travelling in the leftmost lane.

As can be seen, a motorcycle M is also travelling in the same direction as cars A, B, C and D. Motorcycle M now wishes to perform a “lane-splitting” manoeuver.

Motorcycle lane-splitting is legal in some jurisdictions (such as California) and simply involves the motorcycle sharing a lane together with a car (i.e.: the car and the motorcycle travelling together in the same traffic lane, side-by-side one another). A danger of motorcycle lane-splitting is that the safety distance between the car and the motorcycle at its side may be minimal, or even dangerously small when lane spacing is tight. Car and other motor vehicle drivers in such lane-splitting states have become somewhat used to motorcycles attempting such lane splitting. Lane-splitting is typically only done when the motorcycle is passing the car, so it is over quite quickly. Commonly, the car drivers will move slightly to the right (when the motorcycle is passing on their left side) or vice versa, to increase the safety distance between themselves and the motorcycle. Unfortunately, however, not all car drivers show such curtesy to motorcycles. Another problem that car drivers have is that they often do not perceive the approaching motorcycle in the first place. Car drivers tend to see other cars on the road easier than they see motorcycles. This is because the motorcycle is a small object that quickly approaches the rear of the car (and from either side of the car).

The above lane-splitting problems become even more troublesome when motorcycles use lane-splitting to get through traffic jams (another common problem in California). At such times, the car drivers' attentions are primarily focused on the slowing traffic ahead of them and they are braking and reducing speed. This period of reduced car speed is when the motorcycles approach even faster from behind the car. In addition, car drivers are most inclined to change traffic lanes (often frantically) as they approach a traffic jam. This, unfortunately, is the same period of time during which motorcycles are apt to overtake them to try to share the traffic lanes. All of this represents a huge safety problem (for motorcycles and for cars).

In accordance with the present systems and methods, however, motorcycle safety (and car and other motor vehicle safety) is increased since the car can be equipped with the present automatic system for both detecting the presence of a motorcycle, and increasing the safety space between the car and the motorcycle during the lane-splitting maneuver. First, by waring the car drive to the presence of the motorcycle, the car driver will not attempt to change lanes in front of an approaching motorcycle. Second, by automatically steering the car a safe distance away from the motorcycle during lane-splitting, safety is improved.

As will be shown, the present system increases motorcycle safety when only one car is equipped with the present system, or when some or all of the cars travelling on the road are equipped with the present system. As will also be shown, the present system is equally advantageous both when used in current driver assist systems (i.e.: systems that automatically help a human driver optimally steer a car through traffic), or in fully automated driving systems (i.e.: systems in which the driving is fully automated and a human driver does not steer the car). Moreover, as both of these types of driver assist systems become increasingly more common in more and more cars on the road, the present system and methods will beneficially affect safety both for more and more motorcycles and cars over time.

Returning to FIG. 1, only car A is equipped with the present driving assist system for permitting safe motorcycle lane splitting. (Cars B, C and D are not so equipped). In this illustration, car A has at least one of an automated driving assist system (i.e.: a system that helps a human drive) or an autonomous driving system (i.e.: a system that drives the car for the human) operating within the motor vehicle.

Car A has sensors 10 for detecting the presence and motion of objects surrounding the motor vehicle and a control system 20 within the automated driving assist system or an autonomous driving system. Control system 20 interfaces with sensors 10 to sense motorcycle M approaching car A. In the example of FIG. 1, motorcycle M and car A are both traveling in the same direction with motorcycle M travelling faster than car A. As such, that motorcycle M is approaching the left rear side of car A.

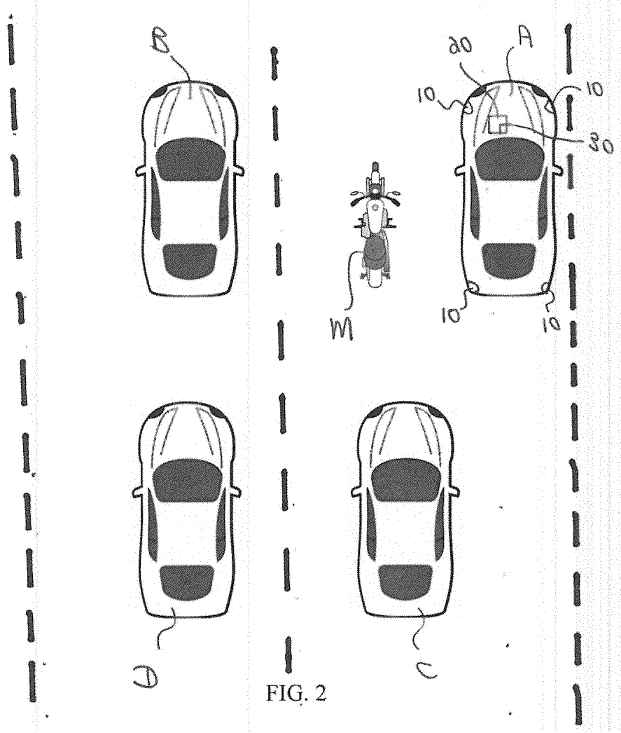

The present control system 20 determines whether motorcycle M will pass car A on its left side or its right side. As can be seen comparing FIG. 1 (taken at an earlier time) and FIG. 2 (taken at a later period of time), motorcycle M is attempting to pass car A on car A's left side. In accordance with the present system, and as illustrated in FIG. 2, control system 20 will thus control the automated driving assist or autonomous driving system to steer car A to the right side of its traffic lane (with motorcycle M passing on the left side of car A).

As can be seen in FIG. 2, motorcycle M and car A are now lane-splitting. In this position and at this period of time, car A will be driving somewhat closer to the right side of its traffic lane to increase the safety separation distance between motorcycle M and car A. It is of course to be understood that if another motorcycle (not illustrated) was also attempting to pass car A but on its right side (for example in the case of a multi-lane freeway), then car A would not steer into the path of the second motorcycle. Rather, car A would simply continue to travel in the center of its traffic lane.

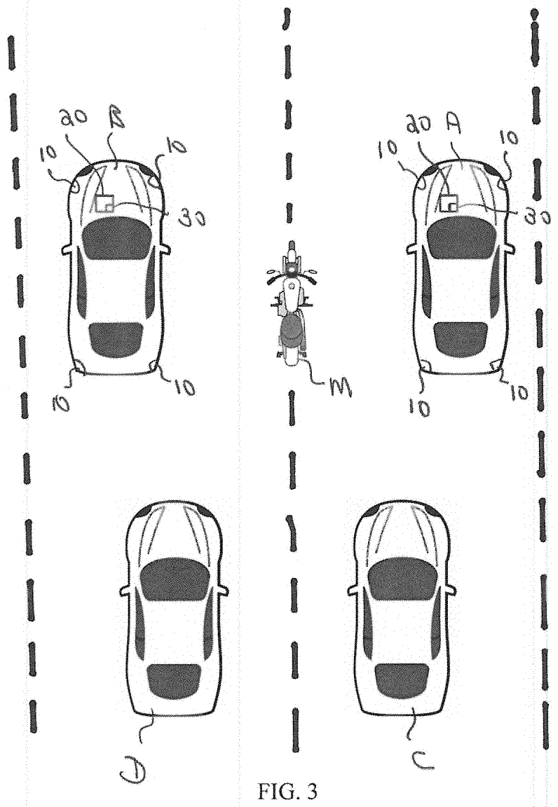

FIG. 3 illustrates the case of two different cars (A and B) both being outfitted with the present driver assist system. As seen in FIG. 3, the motorcycle M is again attempting to lane-split by passing on the left side of car A. However, in this case, car B is also equipped with the present control system 20 such that car B will be steered slightly to the left side of its traffic lane and motorcycle M will pass on the right side of car B. As can be seen, motorcycle M will thus have increased safety spacing on both sides.

Control system 20 (together with sensors 10) determines that a sensed object is a motorcycle by determining the size and speed of the sensed object. In preferred aspects, control system 20 also senses boundaries of the traffic lane and does not steel the motor vehicle across the boundaries of its traffic lane.

In optional preferred embodiments, sensors 10 may comprise a LIDAR system or a camera system. In further optional preferred embodiments, control systems 20 may communicate with one another from one car to another.

In optional preferred embodiments, (presumably those embodiments with systems that assist a human in driving the car or other motor vehicle), the present system also includes a warning system 30 that alerts the human driver that a motorcycle will pass the motor vehicle and that the motor vehicle will automatically move to one side of the traffic lane (or instruct the human driver to steer to one side of the traffic lane). Optionally, the warning system 30 comprises: a mechanism for vibrating a steering wheel, a light on a dashboard or on the rear-view mirror, a chime, or some combination of these. Other warning system possibilities are also contemplated, all keeping within the scope of the present invention.

As illustrated in FIGS. 1 to 3, the present system also includes a method of permitting safe motorcycle lane splitting with a motor vehicle having an automated driving assist or autonomous driving system, comprising: (a) sensing a motorcycle approaching a motor vehicle, wherein the motorcycle and the motor vehicle are traveling in the same direction and the motorcycle is approaching a rear of the motor vehicle; (b) determining whether the motorcycle will pass the motor vehicle on the left side or the right side of the motor vehicle, and then; (c) controlling an automated driving assist or autonomous driving system in the motor vehicle to steer the motor vehicle to the right side of a traffic lane if the motorcycle will pass on the left side of the motor vehicle, and optionally, controlling an automated driving assist or autonomous driving system in the motor vehicle to steer the motor vehicle to the left side of a traffic lane if the motorcycle will pass on the right side of the motor vehicle.

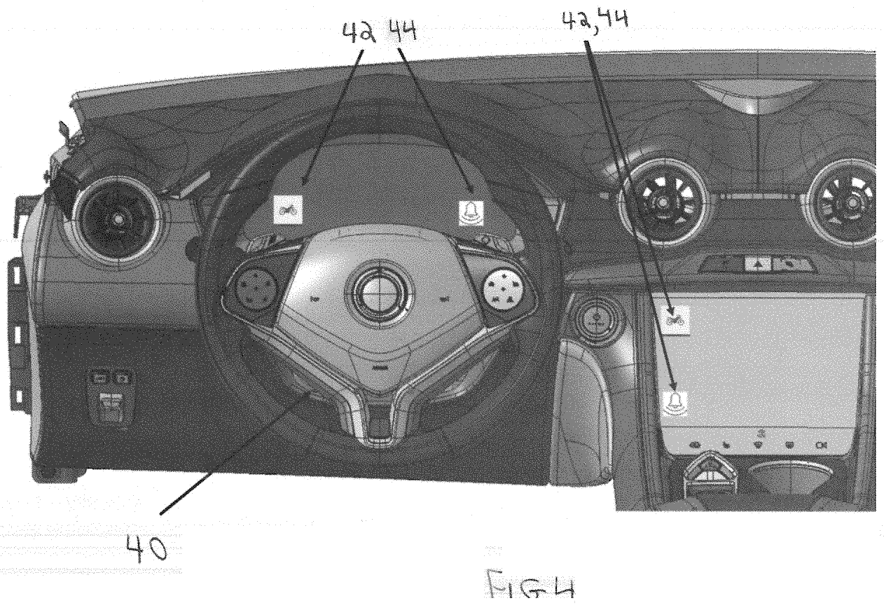

FIG. 4 is an illustration of the warning system of the present system vibrating a steering column, providing a warning light and a chime alert. Specifically, the present warning system may optionally include one or more of the following three systems. First, a vibrating system 40 may be included for vibrating the steering column. Second, a warning light 42 and a chime alert 44 may be included. As illustrated in FIG. 4, the warning light 42 and chime alert 44 may optionally be positioned above or beside the steering column. It is to be understood that operation of the present warning system vibration system 40, warning light 42 and chime 44 may be under user control such that the user may optionally select one, two or three of these systems to be active during driving, depending upon user preferences. For example, one driver may wish to have a vibrating steering wheel whereas another driver may desire a chime whereas another may desire to only use the warning light. Some drivers may wish to use all three warning systems.

What is claimed is:

1. A driving assist system for permitting safe motorcycle lane splitting, comprising:
(a) a motor vehicle;
(b) at least one of an automated driving assist system or an autonomous driving system operating in the motor vehicle;
(c) sensors on the motor vehicle for detecting the presence and motion of objects surrounding the motor vehicle;
(d) a control system within the automated driving assist system or an autonomous driving system for:
(i) sensing a motorcycle approaching the motor vehicle when the motorcycle and the motor vehicle are both traveling in the same direction and the motorcycle is approaching a rear of the motor vehicle;
(ii) determining whether the motorcycle will pass the motor vehicle on the left side or the right side of the motor vehicle, and then;
(iii) controlling the automated driving assist or autonomous driving system to steer the motor vehicle to the right side of a traffic lane if the motorcycle will pass on the left side of the motor vehicle.

2. The system of claim 1, further comprising:
(iv) controlling the automated driving assist or autonomous driving system to steer the motor vehicle to the left side of a traffic lane if the motorcycle will pass on the right side of the motor vehicle.

3. The system of claim 1, wherein the sensors comprise a LIDAR system.

4. The system of claim 1, wherein the sensors comprise a camera system.

5. The system of claim 1, wherein the automated driving assist system assists a person in driving the motor vehicle.

6. The system of claim 5, further comprising:
(e) a warning system that alerts the person that the motorcycle will pass the motor vehicle and that the motor vehicle will move to one side of the traffic lane.

7. The system of claim 6, wherein the warning system comprises:
a mechanism for vibrating a steering wheel,
a light on a dashboard or rear-view mirror, or
a chime.

8. The system of claim 1, wherein the autonomous driving system drives the motor vehicle.

9. The system of claim 1, wherein the control system determines that a sensed object is a motorcycle by determining the size and speed of the sensed object.

10. The system of claim 1, wherein the control system senses boundaries of the traffic lane and does not steel the motor vehicle across the boundaries of the traffic lane.

11. A method of permitting safe motorcycle lane splitting with a motor vehicle having an automated driving assist or autonomous driving system, comprising:
sensing a motorcycle approaching a motor vehicle, wherein the motorcycle and the motor vehicle are traveling in the same direction and the motorcycle is approaching a rear of the motor vehicle;
determining whether the motorcycle will pass the motor vehicle on the left side or the right side of the motor vehicle, and then;
controlling an automated driving assist or autonomous driving system in the motor vehicle to steer the motor vehicle to the right side of a traffic lane if the motorcycle will pass on the left side of the motor vehicle.

12. The method of claim 11, further comprising:
controlling an automated driving assist or autonomous driving system in the motor vehicle to steer the motor vehicle to the left side of a traffic lane if the motorcycle will pass on the right side of the motor vehicle.

13. The method of claim 11, wherein sensing the motorcycle approaching the motor vehicle is performed by a LIDAR system on the motor vehicle.

14. The method of claim 11, wherein sensing the motorcycle approaching the motor vehicle is performed by a camera system on the motor vehicle.

13. The method of claim 11, further comprising:
alerting a driver of the motor vehicle that the motorcycle will pass the motor vehicle and that the motor vehicle will move to one side of the traffic lane.

14. The method of claim 13, wherein the driver is alerted by a light or by a vibration in a steering wheel.

15. The method of claim 11, wherein sensing the motorcycle comprises:
sensing an object approaching the motor vehicle, and then
determining that the object is a motorcycle.

16. The method of claim 15, wherein determining that the object is a motorcycle comprises determining the size and speed of the object.
